(19) United States
(12) Patent Application Publication
(10) Pub. No.: US 2008/0072778 A1
(43) Pub. Date: Mar. 27, 2008

(54) INK CONTROL APPARATUS, PRINTER, AND PRINTING METHOD

(75) Inventors: Hideaki NAGAI, HIROSHIMA-KEN (JP); Masahito KANEKO, HIROSHIMA-KEN (JP)

Correspondence Address: LOWE HAUPTMAN HAM & BERNER, LLP, 1700 DIAGONAL ROAD, SUITE 300, ALEXANDRIA, VA, 22314, US

(73) Assignee: MITSUBISHI HEAVY INDUSTRIES, LTD., TOKYO (JP)

(21) Appl. No.: 11/668,852

(22) Filed: Jan. 30, 2007

(30) Foreign Application Priority Data
Apr. 7, 2006 (JP) 2006-106817

(51) Int. Cl. B41F 31/02; B41F 31/00

(52) U.S. Cl. 101/365; 101/335

(57) ABSTRACT

An image is created from PPF data and the image is displayed. An operator inputs a pre-set value of color adjustment from a color-adjustment-quantity operation screen. The color-adjustment-quantity operation screen includes a print display unit that displays a print color in a print measured by a calorimeter, a color-sample display unit that displays a target color in a color sample measured by the calorimeter, and a corrected-color display unit that displays a corrected color corresponding to a deviation between a calorimetric value of the print and a calorimetric value of the color sample.

### CROSS REFERENCE

The present application is based on, and claims priority from, Japanese Application Number 2006-106817, filed Apr. 7, 2006, the disclosure of which is hereby incorporated by reference herein in its entirety.

### BACKGROUND OF THE INVENTION

1. Field of the Invention

The present invention generally relates to offset printing, and specifically relates to adjustment of ink supply quantity in offset printing.

2. Description of the Related Art

A typical offset printer includes printing units for four ink colors, i.e., cyan, magenta, yellow, and black, are arranged along a conveyance path of paper on which matter is to be printed. Each of the printing units includes an ink supply device. The ink supply device includes an ink fountain roller and a plurality of ink keys. An ink supply quantity corresponding to an ink key is adjusted by adjusting a gap (an ink clearance) between that particular ink key and the ink fountain roller. The ink supply quantity adjusted ink is supplied to a printing plate of a plate cylinder via an ink roller group. The ink on the printing plate is then transferred onto a print sheet as a pattern via a blanket cylinder.

In the ink supply device, the ink keys are arrayed along the print width direction of the corresponding printing unit. Each ink key corresponds to a unit area (ink key zone) in the print width direction. Therefore, color adjustment for the printer requires an extremely high skill for setting a variation in a color after separating color adjustment according to the intention of the operator into a process color and converting the variation into an ink clearance taking into account various factors such as an area ratio of a pattern, the number of revolutions of the ink fountain roller, and printing responsiveness.

FIG. 12 is a flowchart of an operation performed by an operator for adjusting an ink supply quantity in an ink control apparatus in a conventional printer. As shown in FIG. 12, when preparation for printing is completed at step S001, the operator performs test print at step S002. At step S003, the operator views the test print and judges whether color adjustment is necessary. If the color adjustment is not necessary, at step S011, the operator carries out commercial printing. On the other hand, if the color adjustment is necessary, at step S004 and subsequent steps, the operator performs color adjustment work.

At step S004, the operator applies color separation to the test print for each of the ink key zones in which color adjustment is necessary and sets increase/decreases of inks of cyan (c), magenta (m), yellow (y), and black (k). At step S005, the operator takes into account an image area ratio of each of the ink key zones. At step S006, the operator sets an opening adjustment quantity of the ink key for each of the ink key zones. At steps S007 to S010, the operator operates each of the ink keys to adjust an opening of the ink key. Thereafter, returning to step S002, the operator performs test print again. At step S003, the operator views the test print and judges whether the color adjustment is necessary. Color adjustment for an image is performed by repeating the work to realize a desired color of the operator.

A conventional ink control apparatus for a conventional printer has been disclosed in Japanese Patent Application Laid-Open Nos. 2000-085107 and 2004-034375

However, in the ink supply device having, for each of the four printing units, a plurality of ink keys for adjusting an ink supply quantity by a unit of a plurality of ink key zones sectioned in a width direction of a print sheet, when one printing unit has, for example, thirty ink keys, there are one hundred twenty ink keys in the four printing units. Thus, it is complicated work for the operator to operate the one hundred twenty ink keys to perform color adjustment. Moreover, for the operation of the ink keys for performing color adjustment for an image, as described above, it is necessary to take into account various factors such as an area ratio of a pattern, the number of revolutions of the ink fountain roller, and pint responsiveness. Therefore, the operation requires an extremely high skill and a heavy work load is applied to the operator.

In the ink-supply-quantity setting device disclosed in Japanese Patent Application Laid-Open No. 2000-085107, individual setting switches are provided in association with a plurality of ink supply devices. When a set value is inputted by one individual setting switch in a right alignment mode, a value of the individual setting switch on the right side thereof is set in association with the input of the set value. In this case, an operation time for the individual setting switches is reduced. However, when color adjustment is to be performed, it is necessary to operate all the individual setting switches. Thus, it is impossible to solve the problem of complicated setting in the color adjustment work and reduce the work load on the operator.

In the printer disclosed in Japanese Patent Application Laid-Open No. 2004-034375, key operation switches for adjusting openings of respective ink keys are displayed on a display screen in a control panel of a touch panel system. When the operator operates a changeover switch, the key operation switches and a pattern of a print being printed are simultaneously displayed. However, since the operator operates a large number of the ink keys to perform color adjustment for the pattern of the print, the operator has to carry out complicated work.

Thus, there is a need of a technology that allows color adjustment to be performed easily.

### SUMMARY OF THE INVENTION

It is an object of the present invention to at least partially solve the problems in the conventional technology. What is claimed is:

According to an aspect of the present invention, an ink control apparatus includes a display unit that displays a print pattern image based on image information; an area selecting unit that selects a target ink area where color adjustment is to be performed from the image displayed by the display unit; an image selecting unit that selects a representative image in the target ink area; a calorimetric unit that measures a calorimetric value of the representative image in a color sample and a calorimetric value of the representative image in a print; a setting unit that sets, based on the calorimetric value of the color sample and the calorimetric value of the print measured by the calorimetric unit, a color adjustment quantity for the target ink area; and a changing unit that changes, based on the color adjustment quantity set by the setting unit, an ink supply quantity in the target ink area.

According to another aspect of the present invention, a printer includes an ink supply unit that is capable of adjusting an ink supply quantity for each of ink areas sectioned in a print width direction; a display unit that displays a print pattern image based on image information; an area selecting unit that selects a target ink area where color adjustment is to be performed from the image displayed by the display unit; an image selecting unit that selects a representative image in the target ink area; a calorimetric unit that measures a calorimetric value of the representative image in a color sample and a calorimetric value of the representative image in a print; a setting unit that sets, based on the calorimetric value of the color sample and the calorimetric value of the print measured by the calorimetric unit, a color adjustment quantity for the target ink area; and a changing unit that changes, based on the color adjustment quantity set by the setting unit, an ink supply quantity in the target ink area.

According to still another aspect of the present invention, a printing method comprising the steps of, in a printer that is capable of adjusting an ink supply quantity for each of ink areas sectioned in a print width direction includes displaying a print pattern image based on image information; selecting a target ink area where color adjustment is to be performed from the image displayed at the displaying; selecting a representative image in the target ink area; measuring a calorimetric value of the representative image in a color sample and a calorimetric value of the representative image in a print; setting, based on the calorimetric value of the color sample and the calorimetric value of the print measured at the measuring, a color adjustment quantity for the target ink area; and changing, based on the color adjustment quantity set at the setting, an ink supply quantity in the target ink area.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic of an operation unit of an ink control apparatus according to a first embodiment of the present invention;

FIG. 2 is an external view of the ink control apparatus shown in FIG. 1;

FIG. 3 is a block diagram of the ink control apparatus shown in FIG. 1;

FIG. 4 is a processing block diagram of ink supply quantity control by the ink control apparatus in the printer according to the first embodiment;

FIG. 5 is a schematic for explaining ink supply quantity control performed by the ink control apparatus shown in FIG. 1;

FIG. 6 is a graph of a variation in an ink clearance with respect to an image area ratio;

FIG. 7 is a flowchart of ink supply quantity control by the ink control apparatus shown in FIG. 1;

FIG. 8 is a schematic of an offset printer according to the first embodiment;

FIG. 9 is a schematic of an operation unit of an ink control apparatus according to a second embodiment of the present invention;

FIG. 10 is a schematic of the ink control apparatus in the printer according to the second embodiment;

FIG. 11 is a schematic of the operation unit of the ink control apparatus in the printer according to the second embodiment; and

FIG. 12 is a flowchart of an ink supply quantity control performed by a conventional ink control apparatus.

### DETAILED DESCRIPTION OF THE PREFERRED EMBODIMENTS

Exemplary embodiments according to the present invention are explained in detail below with reference to the accompanying drawings. The present invention is not limited by the following embodiments.

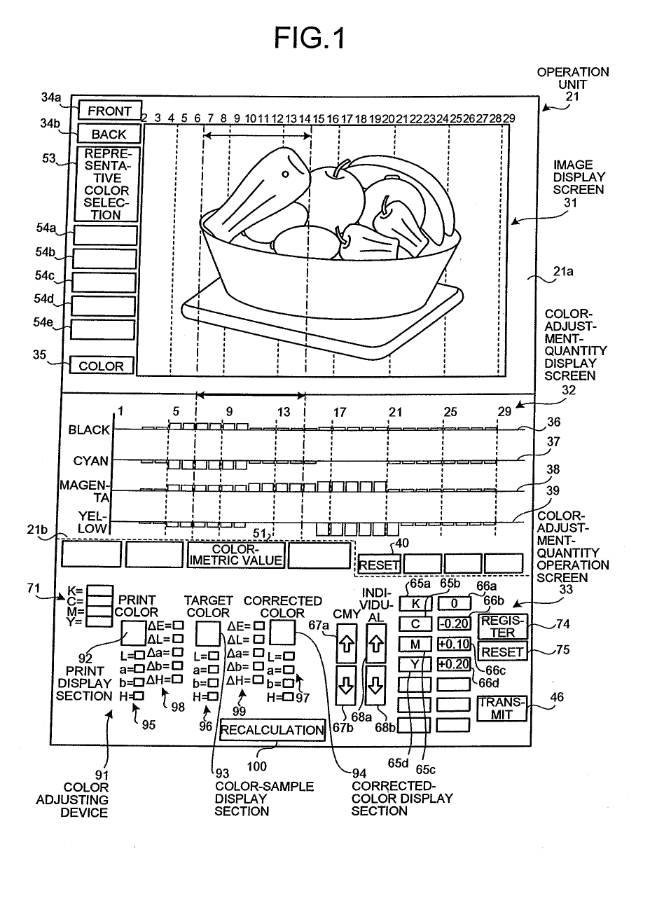

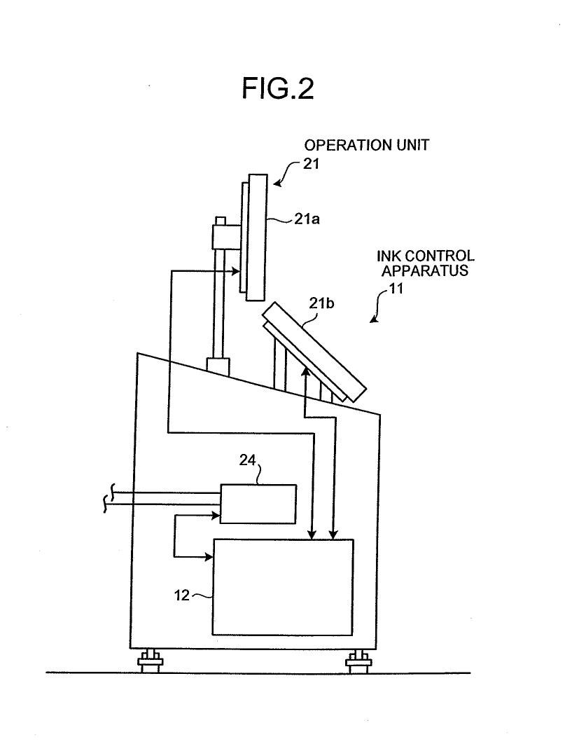

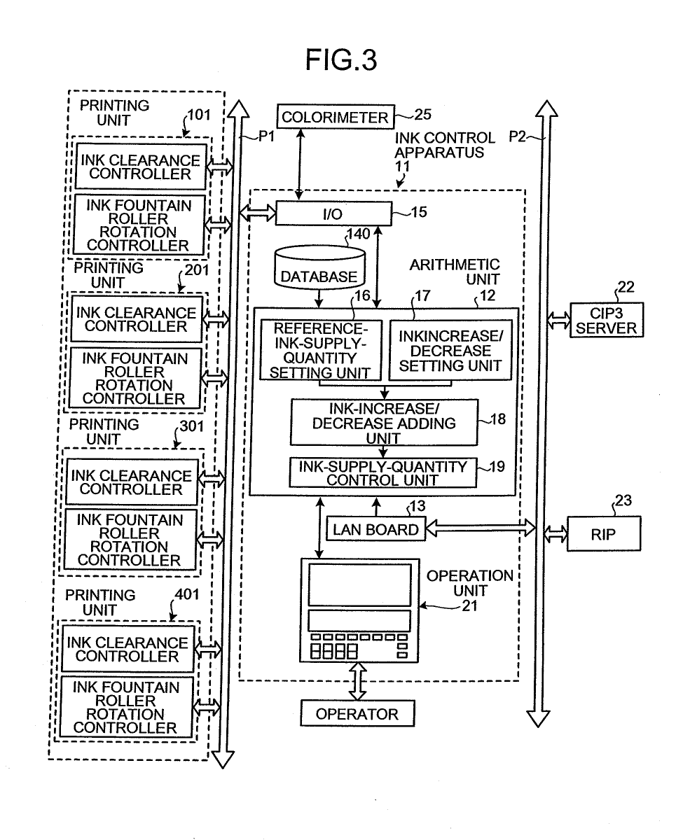

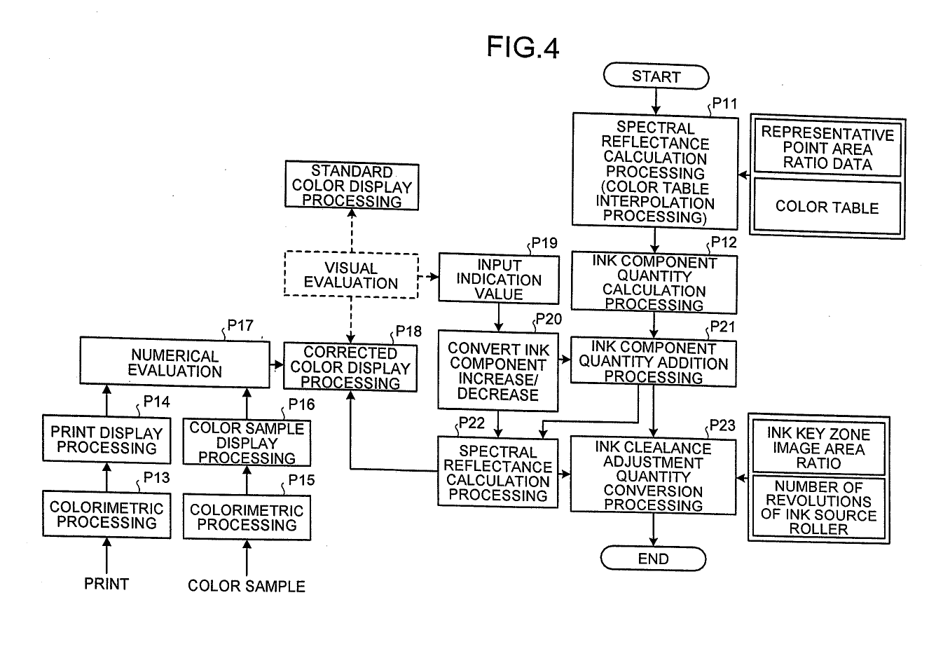

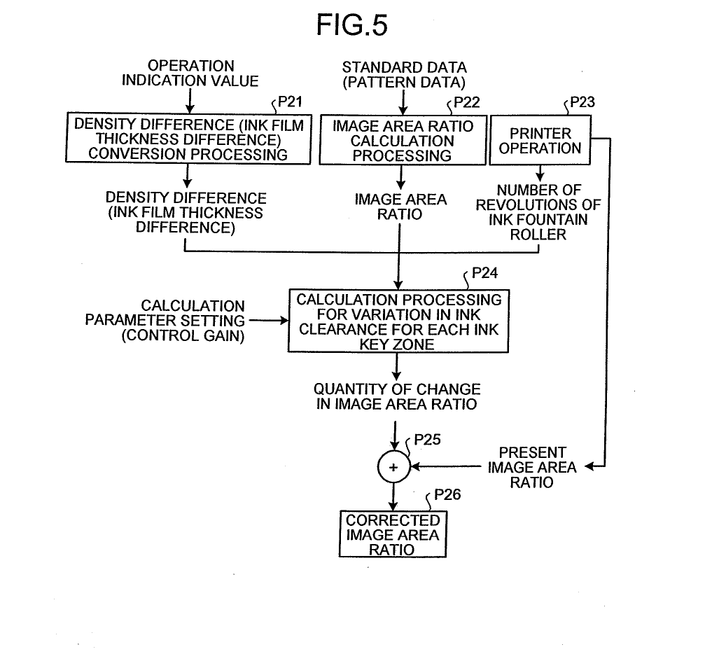

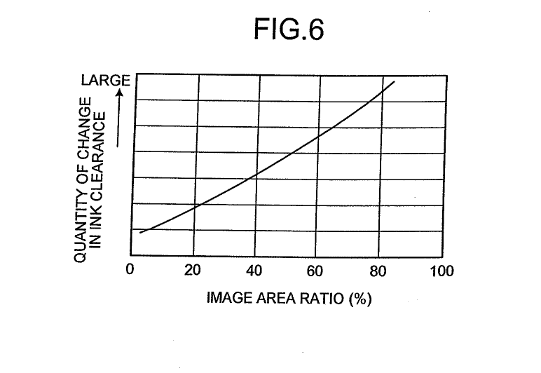

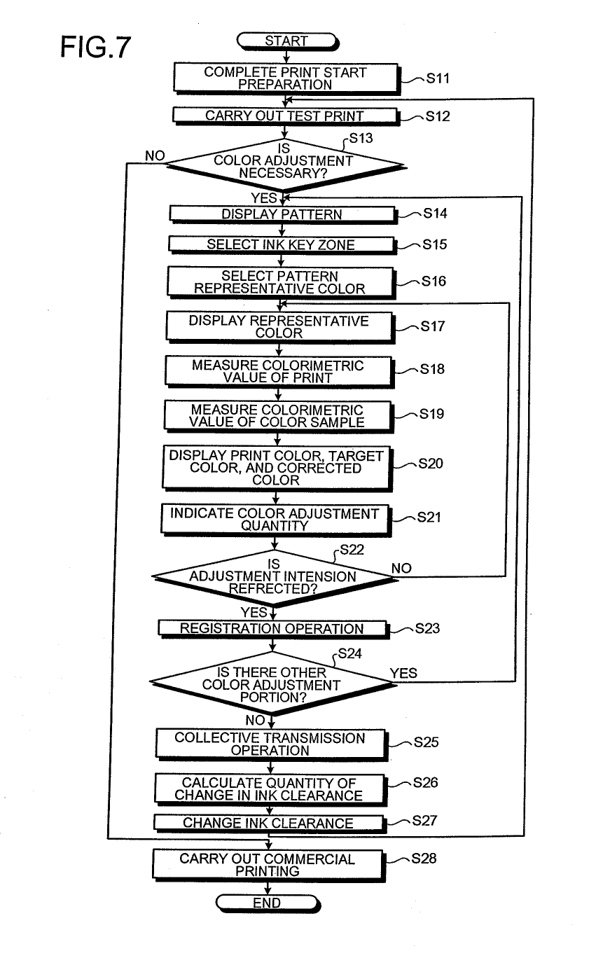

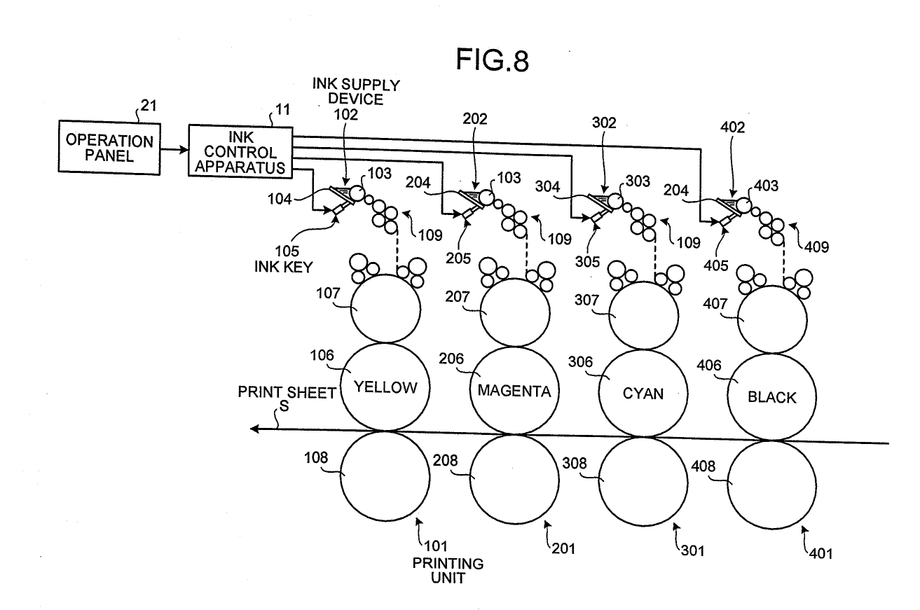

FIG. 1 is a schematic of an operation unit of an ink control apparatus in a printer according to a first embodiment of the present invention. FIG. 2 is an external view of the ink control apparatus in the printer according to the first embodiment. FIG. 3 is a block diagram of the ink control apparatus in the printer according to the first embodiment. FIG. 4 is a processing block diagram of ink supply quantity control by the ink control apparatus in the printer according to the first embodiment. FIG. 5 is a processing block diagram of ink supply quantity control for each of ink key zones of the ink control apparatus in the printer according to the first embodiment. FIG. 6 is a graph of a variation in an ink clearance with respect to an image area ratio. FIG. 7 is a flowchart of ink supply quantity control by the ink control apparatus in the printer according to the first embodiment. FIG. 8 is a schematic of an offset printer to which the printer according to the first embodiment is applied.

In the offset printer to which the ink control apparatus according to the first embodiment are applied, as shown in FIG. 1, printing units 101, 201, 301, and 401 are set for cyan, magenta, yellow, and black as ink colors, respectively, along a conveyance path for a print sheet S. Ink supply devices 102, 202, 302, and 402 are provided in the printing units 101, 201, 301, and 401, respectively. The ink supply devices 102, 202, 302, and 402 have ink fountain devices including ink fountain rollers 103, 203, 303, and 403 and ink blades 104, 204, 304, and 404, respectively. Further, the ink supply devices 102, 202, 302, and 402 have ink keys 105, 205, 305, and 405 capable of adjusting gaps (ink clearances) between the ink fountain rollers 103, 203, 303, and 304 and the ink blades 104, 204, 304, and 404 using adjustment screws. In the case of this embodiment, a plurality of the ink keys 105, 205, 305, and 405 are provided in a print width direction. The ink keys 105, 205, 305, and 405 adjust an ink supply quantity for each ink area as a width unit of the ink keys 105, 205, 305, and 405, i.e., each of ink key zones in this embodiment. In an apparatus in which ink keys is divided at a very small width, one ink area and a plurality of ink key zones may be associated with each other to adjust an ink supply quantity, for example, ink keys may be selected as a set.

Blanket cylinders 106, 206, 306, and 406 and plate cylinders 107, 207, 307, and 407 are arranged above the conveyance path for the print sheet S. On the other hand, impression cylinders 108, 208, 308, and 408 are arranged below the conveyance path for the print sheet S. Ink roller groups 109, 209, 309, and 409 are arranged between the ink supply devices 102, 202, 302, and 402 and the plate cylinders 107, 207, 307, and 407. Therefore, inks whose quantities are adjusted by the ink keys 105, 205, 305, and 405 of the ink supply devices 102, 202, 302, and 402 are properly kneaded by the ink roller groups 109, 209, 309, and 409 to form thin films. Then, the inks are supplied to printing surfaces of the plate cylinders 107, 207, 307, and 407. The inks adhering to the printing surfaces are transferred onto the print sheet S as patterns via the blanket cylinders 106, 206, 306, and 406.

In the offset printer according to this embodiment constituted as described above, the four printing units 101, 201, 301, and 401 have the ink supply devices 102, 202, 302, and 402, respectively. The ink keys 105, 205, 305, and 405 provided in association with the printing units can adjust an ink supply quantity for each of a plurality of (in this embodiment, thirty) ink key zones sectioned in the print width direction. In this embodiment, in applying color adjustment to a test print, when an operator inputs an indication value (i.e., a pre-set value) for color adjustment, the ink keys 105, 205, 305, and 405 automatically calculate an increase/decrease for each of ink components of all ink key zones (ink areas) in which color adjustment is performed. The ink keys 105, 205, 305, and 405 add the increase/decrease for each of the ink components to a supply quantity for each of the ink components that are set based on printing reference data (image information) and set an ink supply quantity for each of the ink components.

In the apparatus structure of the ink control apparatus in the offset printer according to this embodiment, as shown in FIGS. 2 and 3, an ink control apparatus 11 is connected to the printing units 101, 201, 301, and 401 via a first parallel path line P1. The ink control apparatus 11 is capable of controlling ink clearances set by the ink keys 105, 205, 305, and 405 (ink clearance controllers), the numbers of revolutions of the ink fountain rollers 103, 203, 303, and 403 (ink fountain roller rotation controllers), and the like. The ink control apparatus 11 has an arithmetic unit 12 as a color-adjustment-quantity setting unit that sets a color adjustment quantity for each of the ink key zones. A LAN board 13, a database 140, and an input/output port 15 are connected to the arithmetic unit 12. The arithmetic unit 12 has a reference-ink-supply-quantity setting unit 16, an ink-increase/decrease setting unit 17, an ink increase/decrease adding unit 18, and an ink-supply-quantity control unit 19. In this embodiment, the ink-increase/decrease setting unit 17, the ink increase/decrease adding unit 18, and the ink-supply-quantity control unit 19 constitute an ink-supply-quantity changing unit.

The ink control apparatus 11 has an operation unit 21 with which the operator is capable of operating the arithmetic unit 12 and the like from a remote location. The operation unit 21 includes upper and lower two touch panels 21a and 21b. The operation unit 21 has a display function (display means) for displaying images on touch panels 21a and 21b based on print production format (PPF) data as print reference data and a color adjusting unit selecting function (color-adjustment-ink-area selecting means) for selecting, from the image displayed, a plurality of ink key zones in which the operator selects and operates the touch panels 21a and 21b with a finger tip to perform color adjustment.

The ink control apparatus 11 is connected to a CIP3 (cooperation for integration of prepress, press, postpress) server 22 and a raster image processor (RIP) 23 via a second parallel path line P2. To set an ink supply quantity of the offset printer, the CIP3 server 22 outputs PPF data including an image area ratio of a print image to the ink control apparatus 11 through the second path line P2. The RIP 23 replaces print image data with halftone dot data. The RIP 23 passes the halftone dot data to the CIP3 server 22 to create PPF data. In FIG. 2, a hub 24 is connected to the arithmetic unit 12 and the parallel path lines P1 and P2 are connected to the hub 24.

Moreover, in this embodiment, a calorimeter (calorimetric means) 25 is connected to the ink control apparatus 11. This calorimeter 25 is capable of measuring color values, i.e., an L value, an “a” value, a “b” value, and an H value, density values Dc, Dm, Dy, and Dk, and a spectral reflectance R(λ). For color adjustment, the calorimeter 25 uses the L value, the “a” value, the “b” value, and the H value. The calorimeter 25 can measure a calorimetric value of a representative image in a color sample and a calorimetric value of a representative image in a print.

As shown in FIGS. 1 to 3, the operation unit 21 is a display of a touch panel type. An operator is capable of operating the operation unit 21 by touching a screen thereof with a finger tip. The operation unit 21 has an image display screen 31 that displays a print pattern image based on the PPF data by sectioning the print pattern image into ink key zones, a color-adjustment-quantity display screen 32 that displays a set color adjustment quantity for each of the ink key zones, and a color-adjustment-quantity operation screen 33 that displays the color adjustment quantity.

The image display screen 31 can display a print image based on the PPF data. In this case, the respective ink keys 105, 205, 305, and 405 of the ink supply devices 102, 202, 302, and 402 adjust an ink supply quantity for each of thirty ink key zones sectioned in the print width direction. Thus, supplementary lines for sectioning the print image into the thirty ink key zones are displayed and ink key zone numbers (No. 1 to 30) are displayed on the image display screen 31. In a side part of the image display screen 31, sheet selection switches 34a and 34b for selecting the front and the back of a print sheet and a color selection switch 35 for displaying an image with one of black, cyan, magenta, and yellow as four ink colors are provided. Further, in a side part of the image display screen 31, a representative-color selection switch 53 for selecting a representative image (a representative color) in the image displayed on the image display screen 31 is provided. Moreover, five representative-color display sections (storing units) 54a, 54b, 54c, 54d, and 54e that store and display the representative color selected are provided.

Therefore, for example, when an image of a large number of fruits in a basket is displayed on the image display screen 31 and the operator desires to adjust a color of a specific fruit in the image of the fruits, the operator can set ink key zones, in which color adjustment is performed, by touching the ink key zones No. 7 to 14, in which the fruit is present, with a finger tip to select the ink key zones. When the operator desires to perform color adjustment for a specific portion of the fruit, the operator can display an image of the specific portion on one of the five representative-color display sections 54a, 54b, 54c, 54d, and 54e and store the image therein by touching the representative-color selection switch 53 and, then, touching the specific portion (a representative image) of the fruit with a fingertip. In this case, it is possible to store five representative images. The operator can also display the image of the specific portion on one of the representative-color display sections 54a, 54b, 54c, 54d, and 54e and store the image therein by touching the specific portion (the representative image) of the fruit with a finger tip and, then, touching the representative-color selection switch 53.

In the color-adjustment-quantity display screen 32, four display sections 36, 37, 38, and 39 that display a color adjustment quantity for each of the ink key zones of the image are provided in association with black (K), cyan (C), magenta (M), and yellow (Y) as the four ink colors. In this case, horizontal lines in the respective display sections 36, 37, 38, and 39 are the last adjustment reference values, increases in color adjustment quantities to be adjusted this time are displayed as bar graphs extending upward, and decreases in the color adjustment quantities are displayed as bar graphs extending downward. Reset switches 40 for resetting adjustment quantities of the adjusted respective ink colors to zero are provided below the color-adjustment-quantity display screen 32. In the color-adjustment-quantity display screen 32, as in the image display screen 31, it is possible to set ink key zones in which color adjustment is performed.

The color-adjustment-quantity operation screen 33 includes a color adjusting device 91 for setting color adjustment quantities (increases or decreases) for black (K), cyan (C), magenta (M), and yellow (M) as three ink colors. The color adjusting device 91 includes a print display section 92 that displays an image (a print color) based on a calorimetric value of the representative image in a print measured by the calorimeter 25, a color-sample display section 93 that displays an image (a target color) based on a calorimetric value of the representative image in a color sample measured by the calorimeter 25, and a corrected-color display section 94 that displays a corrected color corresponding to a deviation between the calorimetric value of the representative image in the print and the calorimetric value of the representative image in the color sample.

A print-color-value display section 95 that displays the calorimetric value of the print measured by the calorimeter 25 as a color value in the CIELAB color space is provided below the print display section 92. A color-sample-color-value display section 96 that displays the calorimetric value of the color sample measured by the calorimeter 25 as a color value in the CIELAB color space is provided below the color-sample display section 93. A corrected-color-value display section 97 that displays the calorimetric value corresponding to the deviation between the calorimetric value of the print and the calorimetric value of the color sample as a color value in the CIELAB color space is provided below the corrected-color display section 94.

Moreover, a first color-value-deviation display section 98 that displays the deviation between the calorimetric value of calorimetric value of the color sample measured by the calorimeter 25 and the calorimetric value of the print measured by the calorimeter 25 as a color value in the CIELAB color space is provided between the print display section 92 and the color-sample display section 93. A second color-value-deviation display section 99 that displays a deviation between the calorimetric value of the color sample measured by the calorimeter 25 and an estimated color value at the time when color adjustment for a print color is carried out as a color value in the CIELAB color space is provided between the color-sample display section 93 and the corrected-color display section 94. A recalculation switch 100 is provided in the lower part of the color adjusting device 91.

In this case, representative colors of representative images displayed on the display sections 92, 93, and 94 are representative colors of a representative image selected with the representative-color selection switch 53. An area-ratio display section 71 that displays area ratios of respective colors in this representative image is provided above the color adjusting device 91.

In a lateral direction of the color adjusting device 91, selection switches 65a, 65b, 65c, and 65d corresponding to cyan (C), magenta (M), yellow (Y), and black (K) are provided and control-quantity display sections 66a, 66b, 66c, and 66d that display control quantities (adjustment quantities) of the respective colors are provided. Density adjustment switches 67a and 67b for increasing and decreasing cyan (C), magenta (M), and yellow (Y) by the same quantity, i.e., adjusting densities thereof are provided and individual adjustment switches 68a and 68b for individually increasing and decreasing cyan (C), magenta (M), yellow (Y), and black (K) are provided next to the selection switches and the control-quantity display sections.

A calorimeter switch 51 is provided in the upper part of the color-adjustment-quantity operation screen 33. A registration switch 74, a reset switch 75, and a transmission switch 46 are provided in a side part of the color-adjustment-quantity operation screen 33.

Therefore, when an ink key zone in which color adjustment is performed is set and a representative image is selected with the representative-color-selection switch 53 in the image display screen 31 (or the color-adjustment-quantity display screen 32), the operator can input an indication value (an increase value or a decrease value) for color adjustment using the color adjusting device 91 in the color-adjustment-quantity operation screen 33. In other words, when the operator measures a calorimetric value of the representative image in a print using the calorimeter 25, a print color based on the calorimetric value is displayed on the print display section 92 and a color value is displayed on the print-color-value display section 95. When the operator measures a calorimetric value of the representative image in a color sample using the calorimeter 25, a target color based on the calorimetric value is displayed on the color-sample display section 93 and a color value is displayed on the color-sample-color-value display section 96. Moreover, a corrected color corresponding to a deviation between the calorimetric value of the representative image in the print and the calorimetric value of the representative image in the color sample is displayed on the corrected-color display section 94. A color value corresponding to a deviation between the calorimetric value of the print and the calorimetric value of the color sample is displayed on the corrected-color-value display section 97.

Then, according to the corrected color displayed on the corrected-color display section 94 and the color value displayed on the corrected-color-value display section 97, an indication value for the corrected color and the color value, i.e., an increase/decrease for each of black (K), cyan (C), magenta (M), and yellow (Y) as the ink components is displayed on the control-quantity display sections 66a, 66b, 66c, and 66d as a numerical value. The increase/decrease is also displayed on the color-adjustment-quantity display screen 32 as a bar graph.

The operator can perform color adjustment while comparing the representative colors displayed on the respective display sections 92, 93, and 94. Moreover, the operator can perform color adjustment while looking at the control-quantity display sections 66a, 66b, 66c, and 66d, the area-ratio display section 71, and a color-difference display section 72 as standards.

In this case, when color adjustment work for each of ink key zones selected is performed a plurality of times, a color adjustment quantity added with the increase/decrease for each of black (K), cyan (C), magenta (M), and yellow (Y) as the ink components is displayed on the color-adjustment-quantity display screen 32. In other words, a total quantity of color adjustment quantities for the ink components is displayed on the color-adjustment-quantity display screen 32. The operator can collectively transmits the total quantity of the color adjustment quantities displayed on the color-adjustment-quantity display screen 32 to the arithmetic unit 12 by operating the transmission switch 46.

Processing by the ink control apparatus 11 controlled by the operation unit 51 is explained in detail. When the operator inputs an indication value (an increase/decrease) of color adjustment with the operation unit 51, the indication value for color adjustment is outputted to the arithmetic unit 12 of the ink control apparatus 11. An ink supply quantity for each of the ink components is set.

As shown in FIGS. 3 and 4, in a processing block P31, when a representative point (a representative image) is selected in the image display screen 31 of the operation unit 21, the ink control apparatus 11 acquires halftone area ratio data of the representative point from the PPF data, calculates a spectral reflectance using a color table in which a relation between a halftone area ratio and a spectral reflectance is described, and calculates a color value (a Lab value, etc.) of a standard color. In a processing block P32, the ink control apparatus 11 calculates an ink supply quantity for each of the ink components based on the spectral reflectance of the representative point calculated.

The ink control apparatus 11 calculates the ink supply quantity for each of the ink components before adjustment using Equation 1 below. The ink control apparatus 11 uses the spectral reflectance at the halftone area ratio of the representative point calculated as described above to convert the spectral reflectance into a spectral density.

The ink control apparatus 11 determines a spectral density of a single color serving as a reference from the halftone area ratio of the representative point and substitutes the spectral density in Equation 1. The ink control apparatus 11 performs a multiple regression calculation using Equation 1 to calculate ink component quantities tc, tm, ty, and tk for each of the ink components.

$$[ \begin{matrix}{D}_{( 380 nm )} \\ {D}_{( 390 nm )} \\ ⋮ \\ {D}_{( 360 nm )}\end{matrix} ] = [ \begin{matrix}{Dc}_{( 380 nm )} & {Dm}_{( 380 nm )} & {Dy}_{( 380 nm )} & {Dk}_{( 380 nm )} \\ {Dc}_{( 390 nm )} & {Dm}_{( 390 nm )} & {Dy}_{( 390 nm )} & {Dk}_{( 390 nm )} \\ ⋮ & ⋮ & ⋮ & ⋮ \\ {Dc}_{( 860 nm )} & {Dm}_{( 860 nm )} & {Dy}_{( 860 nm )} & {Dk}_{( 860 nm )}\end{matrix} ] \times [ \begin{matrix}{t}_{c} \\ {t}_{m} \\ {t}_{y} \\ {t}_{k}\end{matrix} ]$$

D(λ)=−log(R(λ)/Rzero(λ)): Spectral density of a designated area ratio

R(λ): Reflectance at the designated area ratio

Rzero(λ): Reflectance at an area ratio zero (a white paper portion)

Dc(λ): Spectral density of a reference cyan color stored in advance

Dm(λ): Spectral density of a reference magenta color stored in advance

Dy(λ): Spectral density of a reference yellow color stored in advance

Dk(λ): Spectral density of a reference black color stored in advance

tc: Ink component quantity of cyan

tm: Ink component quantity of magenta

ty: Ink component quantity of yellow

tk: Ink component quantity of black

On the other hand, when the operator performs visual evaluation looking at a test print and performs color adjustment, in a processing block P13, the operator measures the print with the calorimeter 25 to perform calorimetric processing. In a processing block P14, the ink control apparatus 11 displays a calorimetric value of a representative image of the print on the print display section 92. In a processing block P15, the ink control apparatus 11 measures a color sample with the calorimeter 25 to perform calorimetric processing. In a processing block P16, the ink control apparatus 11 displays a calorimetric value of a representative image in the color sample on the color-sample display section 93. Then, in a processing block P17, the ink control apparatus 11 subjects the calorimetric value of the print and the calorimetric value of the color sample to numerical evaluation to display a corrected color corresponding to a deviation between the calorimetric value of the representative image in the print and the calorimetric value of the representative image in the color sample on the corrected-color display section 94 in a processing block P18. The operator performs visual evaluation looking at the corrected-color display section 94 to determine an indication value. In a processing block P19, the operator inputs the indication value for color adjustment using the color adjusting device 91 of the operation unit 51.

Then, in a processing block P20, the ink control apparatus 11 sets a quantity of ink increase/decrease for each of the ink components based on the indication value for color adjustment (the ink-increase/decrease setting unit 17). In a processing block P21, the ink control apparatus 11 adds a quantity of ink component increase/decrease to the ink component quantities tc, tm, ty, and tk calculated as described above (the ink increase/decrease adding unit 18). In a processing block 22P, the ink control apparatus 11 calculates a spectral reflectance based on a quantity of ink change for each of the ink components and displays a corrected color on the corrected-color display section 94 again taking the indication value into account. On the other hand, in a processing block P23, the ink control apparatus 11 controls ink supply quantities supplied by the large number of the ink keys 105, 205, 305, and 405 in the ink supply devices 102, 202, 302, and 402 according to an ink supply quantity for each of the ink components changed (the ink-supply-quantity control unit 19).

In the processing described above, the ink control apparatus 11 displays a corrected color corresponding to a deviation between a calorimetric value of the representative image in a print and a calorimetric value of the representative image in a color sample and the operator performs visual evaluation looking at the corrected-color display section 94 and inputs an indication value for color adjustment. However, an indication value that minimizes the deviation between the calorimetric value of the print and the calorimetric value of the color sample may be automatically calculated according to an iterative calculation (e.g., an annealing method).

In this embodiment, as described above, when a plurality of ink key zones are selected and an indication value for color adjustment is collectively set for the ink key zones selected, color adjustment for each of the ink key zones is set. In this case, even if the indication value for color adjustment is set for the ink key zones, since an image area ratio is different for each of the ink key zones, an ink supply quantity, i.e., an ink clearance is set according to this image area ratio and the number of revolutions of the ink fountain roller.

As shown in FIG. 5, in a processing block P21, the ink control apparatus 11 subjects, based on the indication value inputted by the operator through the color-adjustment-quantity operation screen 33, a density difference between the indication value and a present density of an ink color (an ink film thickness) to conversion processing. In a processing block P22, the ink control apparatus 11 calculates an image area ratio for each of the ink key zones based on the PPF data. In a processing block P23, the ink control apparatus 11 outputs the numbers of revolutions of the ink fountain rollers in the ink supply devices 102, 202, 302, and 402.

In a processing block P24, the ink control apparatus 11 calculates a variation in an ink clearance for each of the ink key zones. In this case, the ink control apparatus 11 sets a control gain according to a parameter table set in advance using image area ratios and the numbers of revolutions of the ink fountain rollers and calculates a variation in an ink clearance using the density difference and the control gain. In this embodiment, this calculation method is formed as a map shown in FIG. 6. The ink control apparatus 11 sets a variation in an ink clearance with respect to an image area ratio using this map. Thereafter, in a processing block P25, the ink control apparatus 11 adds the variation in an ink clearance set to a present ink clearance to set a corrected ink clearance in a processing block P26.

In this processing for setting an ink clearance, in this embodiment, the ink control apparatus 11 sets a variation in an ink clearance with respect to an image area ratio using the map set in advance. However, the ink control apparatus 11 may calculate a variation in an ink clearance with an equation according to a parameter table using the image area ratio, the number of revolutions of the ink fountain roller, and the like.

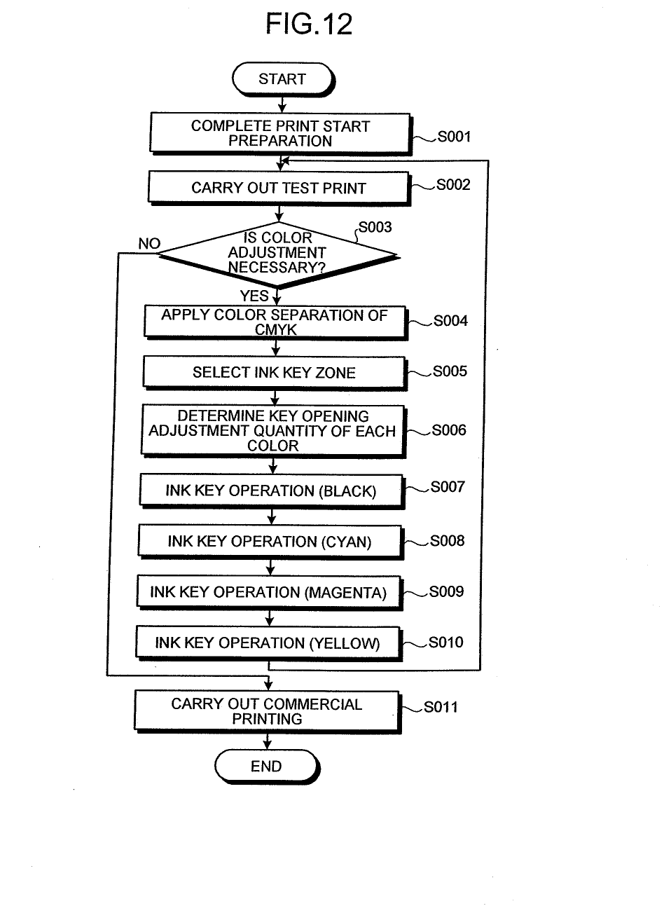

An ink-supply-quantity control method by the ink control apparatus 11 in the offset printer according to this embodiment is explained below using a flowchart in FIG. 7. In the ink-supply-quantity control method by the ink control apparatus 11, pre-print preparation such as attachment of a printing plate to a plate cylinder and pre-inking is completed at step S11 as shown in FIG. 12. At step S12, the operator operates a not-shown test print switch to carry out test print of an image that is set based on the PPF data. The operator carries out this test print work by controlling the ink clearance controllers and the ink fountain roller rotation controllers of the ink supply devices 102, 202, 302, and 402 according to a reference ink supply quantity that is set based on the PPF data and actuating the printing units 101, 201, 301, and 401.

When this test print ends, at step S13, the operator visually evaluates a print image test-printed and judges whether color adjustment work is necessary. When it is judged that color adjustment work for the print image test-printed is unnecessary, the operator shifts to step S28 and operates a not-shown commercial printing switch to carry out commercial printing. On the other hand, when it is judged that color adjustment work for the print image test-printed is necessary, the operator starts color adjustment work for the print image at step S14 and subsequent steps.

First, at step S14, the operator displays an image that is set based on the PPF data, i.e., a pattern of fruits on the image display screen 31 of the operation unit 21. At step S15, when the operator desires to adjust a color of a predetermined fruit in the pattern of the fruits displayed, the operator selects ink key zones among the ink key zones No. 7 to 14, in which the fruit is present, with a finger tip. Subsequently, at step S16, when the operator desires to subject a specific portion of the fruit in the ink key zones selected to color adjustment, the operator touches the representative-image selection switch 53 and, then, touches the specific portion in the fruit (a representative image) with a fingertip. Then, at step S17, an image (a color) of the specific portion of the fruit selected is displayed on, for example, the representative-color display section 54a and stored therein.

At step S18 and subsequent steps, the operator operates the calorimeter switch 51 and, then, performs color adjustment work using the calorimeter 25 and the color adjusting device 93 of the color-adjustment-quantity operation screen 33. At step S18, the operator measures a calorimetric value of a representative image in a test print using the calorimeter 25. At step S19, the user measures a calorimetric value of a representative image of a color sample using the calorimeter 25. Then, at step S20, when a print color based on the calorimetric value of the representative image in the print is displayed on the print display section 92 and a color value is displayed on the print-color-value display section 95. A target color based on the calorimetric value of the representative image in the color sample is displayed on the color-sample display section 93 and a color value is displayed on the color-sample-color-value display section 96. Moreover, a corrected color corresponding to a deviation between the calorimetric value of the representative image in the print and the calorimetric value of the representative image in the color sample is displayed on the corrected-color display section 94. A color value corresponding to the deviation of the calorimetric value of the print and the calorimetric value of the color sample is displayed on the corrected-color-value display section 97.

At step S38, according to a representative color displayed on each of the display sections 92, 93, and 94, the operator adjusts an indication value for the representative color, i.e., an increase/decrease for each of black (K), cyan (C), magenta (M), and yellow (Y) as the ink components. When the corrected color displayed on the corrected-color display section is acceptable, the adjustment work ends. When it is necessary to further adjust the increase/decrease, the operator touches the selection switches 65a, 65b, 65c, and 65d, the density adjustment switches 67a and 67b, and the individual adjustment switches 68a and 68b to input an indication value for color adjustment. At this point, when the operator desires to reset the indication value for color adjustment and perform adjustment again, the operator operates the reset switch 40.

At step S22, the operator judges whether an adjustment intention of the operator is sufficiently reflected on a color after adjustment. When it is judged that the color after adjustment sufficiently reflects the adjustment intention of the operator, at step S23, the operator operates the registration switch 74 to decide the color. Then, adjustment quantities of the respective ink colors are displayed on the display sections 36, 37, 38, and 39 of the color-adjustment-quantity display screen 32. On the other hand, when it is judged at step S22 that the color after adjustment does not sufficiently reflect the adjustment intention of the operator, the operator returns to step S17 and repeats the color adjustment work.

At step S24, the operator judges whether there is a portion to which color adjustment is applied other than the specific fruit. When there is a portion to which color adjustment is applied other than the specific fruit, the operator returns to step S14. The operator selects a specific ink key zone in the image display screen 31 and inputs an indication value using the color adjusting device 91 in the color-adjustment-quantity operation screen 33 as described above. At this point, when ink key zones selected for color adjustment overlap, an indication value adjusted last is processed preferentially.

On the other hand, when it is judged at step S24 that there is no portion to which color adjustment is applied other than the specific fruit, at step S25, the operator operates the transmission switch 46 and collectively transmits indication values of adjustment quantities for the ink key zones set to the arithmetic unit 12. Then, at step S26, the arithmetic unit 12 calculates a quantity of ink increase/decrease for each of the ink components in association with the ink key zones selected based on the indication values of color adjustment. The arithmetic unit 12 adds this quantity of ink increase/decrease to an ink supply quantity for each of the ink components in each of the ink key zones and changes the ink supply quantity for each of the ink components. The arithmetic unit 12 calculates variations in openings of the ink keys 105, 205, 305, and 405 in the ink key zone according to the ink supply quantity for each of the ink components. At step S27, the arithmetic unit 12 changes ink clearances of the large number of the ink keys 105, 205, 305, and 405 in the ink supply devices 102, 202, 302, and 402 based on the ink clearance for each of the ink components changed.

Thereafter, the operator returns to step S12 and carries out test print by operating the test print button. The operator carries out this test print work by controlling the ink clearance controllers and the ink fountain roller rotation controllers of the ink supply devices 102, 202, 302, and 402 according to the ink supply quantity changed by the color adjustment work and actuating the printing units 101, 201, 301, and 401.

When the second test print ends, at step S13, the operator visually evaluates a print image test-printed and judges whether color adjustment work is necessary. When it is judged again that color adjustment work is necessary for the print image test-printed, as described above, the operator starts color adjustment work for the print image at step S14 and subsequent steps. At this point, when the image to be subjected to color adjustment is stored in the representative-color display section 54a, the operator touches the representative-color display section 54a. Consequently, a representative image to be subjected to color adjustment is automatically selected. On the other hand, when it is judged that color adjustment work for the print image is unnecessary, the operator shifts to step S28, carries out commercial printing, and completes the work.

As described above, in the offset printer including the ink control apparatus according to the second embodiment, the ink supply devices 102, 202, 302, and 402 include the ink keys 105, 205, 305, and 405 that are capable of adjusting an ink supply quantity for each of a plurality of ink key zones sectioned in the print width direction. The offset printer includes the operation unit 21 with which the operator is capable of selecting a plurality of ink key zones in which color adjustment is performed from the image display screen 31 that displays a print image based on PPF data and is capable of inputting an indication value for a color adjustment quantity using the color-adjustment-quantity operation screen 33. The arithmetic unit 12 sets a supply quantity for each of the ink components in the ink key zones selected based on standard data of an image. On the other hand, the arithmetic unit 12 sets an increase/decrease for each of the ink components in the ink key zones selected based on the indication value for the color adjustment quantity. The arithmetic unit 12 adds the increase/decrease to the supply quantity for each of the ink components to change the supply quantity for each of the ink components and controls the ink supply devices 102, 202, 302, and 402 according to the supply quantity for each of the ink components changed.

Therefore, when the operator inputs an indication value for a color adjustment quantity for the ink key zones selected for performing color adjustment, an increase/decrease for each of the ink components in each of the ink key zones is set. Thus, it is possible to easily adjust an ink supply quantity for each of the ink key zones sectioned in the print width direction. It is also possible to realize improvement of workability by realizing simplification of color adjustment work. Moreover, it is possible to reduce burdens on the operator.

In this embodiment, the operator selects two or more ink key zones where color adjustment is performed from an image displayed on the image display screen 31. Color adjustment quantities for the ink key zones selected are set as optimum color adjustment quantities different for each of the ink key zones based on an identical indication value, an image area ratio, and the number of revolutions of the ink fountain roller. This makes it possible to adjust ink supply quantities in the ink key zones having different image area ratios easily and in a short time and improve workability.

In this case, even if the operator selects a plurality of ink key zones and indicates an indication value for the same color adjustment quantity for the ink key zones selected, it is impossible to set a proper ink supply quantity because an image area ratio of an image is different for each of the ink key zones. Thus, in the first embodiment, identical indication values for color adjustment quantities indicated for the ink key zones are calculated as optimum values different for each of the ink key zones using an image area ratio, the number of revolutions of the ink fountain roller, and a control gain parameter and an optimum ink supply quantity is set. This makes it possible to set a proper ink supply quantity.

In this embodiment, the color-adjustment-quantity display screen 32 including the four display sections 36, 37, 38, and 39 that display a color adjustment quantity for each of ink key zones of an image is provided in association with the black (K), cyan (C), magenta (M), and yellow (Y) as the four ink colors. All adjustment quantities subjected to color adjustment work for each of the ink key zones selected are added up to display the adjustment quantities on the color-adjustment-quantity display screen 32 as a total quantity of color adjustment quantities for the ink components. When the operator operates the transmission switch 46, the total quantity of the color adjustment quantities displayed on the color-adjustment-quantity display screen 32 is collectively transmitted to the arithmetic unit 12. Therefore, by collectively transmitting the total quantity of the color adjustment quantities to the arithmetic unit 12, it is possible to perform color adjustment work for each of the ink key zones a plurality of times, correct the color adjustment quantities, and reset the color adjustment quantities. This makes it possible to improve workability.

In the offset printer including the ink control apparatus according to the first embodiment, as the color adjusting device 91, the print display section 92 that displays a print color based on a calorimetric value of the representative image in a print measured by the calorimeter 25, the color-sample display section 93 that displays a target color based on a calorimetric value of the representative image in a color sample measured by the calorimeter 25, and the corrected-value display section 94 that displays a corrected color corresponding to a deviation between the calorimetric value of the representative image in the print and the calorimetric value of the representative image in the color sample are provided in the color-adjustment-quantity operation screen 33 of the operation unit 21.

Therefore, the operator can calculate a corrected color for a representative image, i.e., an optimum color adjustment quantity (an increase/decrease) from a print color of the print and the target color of the color sample measured by the calorimeter 25. The operator can easily adjust an ink supply quantity for each of a plurality of ink key zones by simply inputting an indication value of this corrected color as a color adjustment quantity for the ink key zones for performing color adjustment.

Further, the print-color-value display section 95 that displays the calorimetric value of the print as a color value in the CIELAB color space, the color-sample-color-value display section 96 that displays the calorimetric value of the color sample measured by the calorimeter 25 as a color value in the CIELAB color space, and the corrected-color-value display section 97 that displays the calorimetric value corresponding to the deviation between the calorimetric value of the print and the calorimetric value of the color sample as a color value in the CIELAB color space are provided. Thus, the operator can easily perform color adjustment while comparing representative colors displayed on the display sections 95, 96, and 97 in addition to the display sections 92, 93, and 94.

Moreover, the color adjusting device 91 includes the selection switches 65a, 65b, 65c, and 65d corresponding to cyan (C), magenta (M), yellow (Y), and black (K), the control-quantity display sections 66a, 66b, 66c, and 66d, that display adjustment quantities for the respective colors, the density adjustment switches 67a and 67b for adjusting densities, and the individual adjustment switches 68a and 68b for individually increasing or decreasing the respective colors. Therefore, when a color adjustment quantity (a corrected color) based on a calorimetric value measured by the calorimeter 25 is insufficient, the operator can perform color adjustment by operating the selection switches 65a, 65b, 65c, and 65d, the density adjustment switches 67a and 67b, and the individual adjustment switches 68a and 68b.

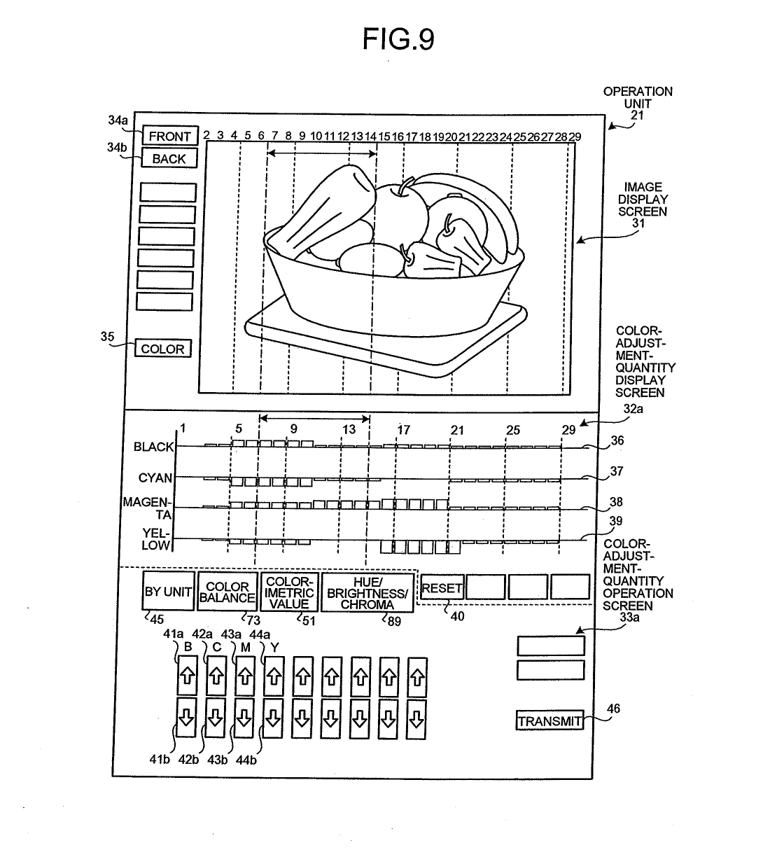

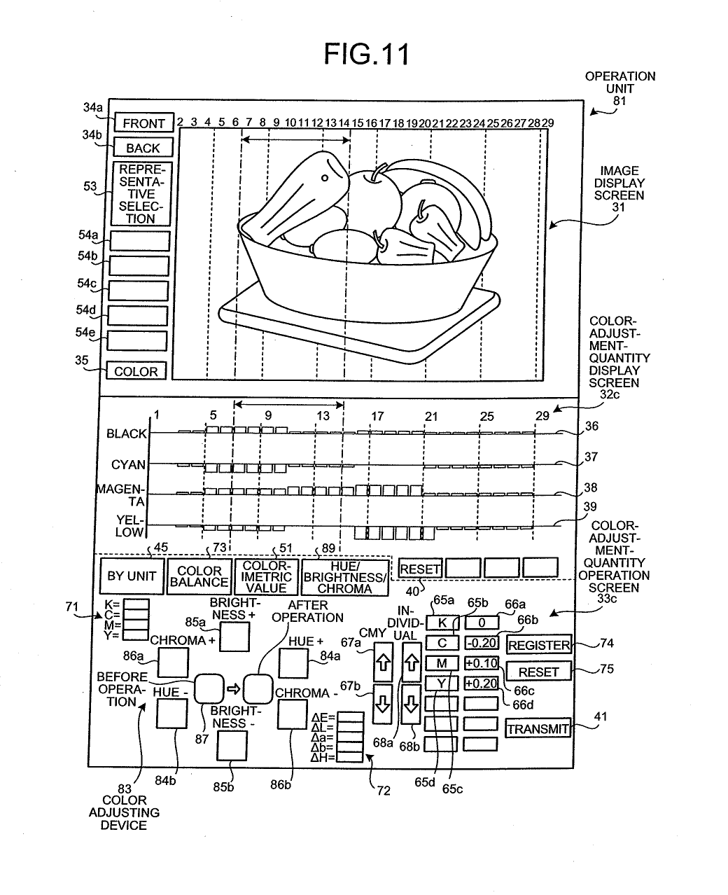

FIGS. 9 to 11 are schematics of an operation unit of an ink control apparatus in a printer according to a second embodiment of the present invention. Members having functions same as those explained in the embodiment described above are denoted by identical reference numerals and signs and redundant explanations of the members are omitted.

In an offset printer including the ink control apparatus according to the second embodiment, a plurality of color adjusting devices are provided in addition to the color adjusting device according to the first embodiment. It is possible to selectively use the color adjusting devices.

As shown in FIG. 9, in the color-adjustment-quantity operation screen 33a of the operation unit 21, a switch by unit 45, a color balance switch 73, a calorimetric value switch 51, and a hue/brightness/chroma switch 89 are provided in the upper part thereof. It is possible to select a color adjustment method for an image displayed on the image display screen 31 by operating the switches 45, 73, 51, and 89.

When an operator operates the switch by unit 45, the image display screen 31, a color-adjustment-quantity display screen 32a, and a color-adjustment-quantity operation screen 33a are displayed. The image display screen 31 can display a print image based on PPF data. In this case, supplementary lines for sectioning the print image into the thirty ink key zones are displayed and ink key zone numbers (No. 1 to 30) are displayed on the image display screen 31. In a side part of the image display screen 31, sheet selection switches 34a and 34b for selecting the front and the back of a print sheet and a color selection switch 35 for displaying an image with one of black, cyan, magenta, and yellow as four ink colors are provided.

Therefore, for example, when an image of a large number of fruits in a basket is displayed on the image display screen 31 and the operator desires to adjust a color of a specific fruit in the image of the fruits, the operator can set ink key zones, in which color adjustment is performed, by touching the ink key zones No. 7 to 14, in which the fruit is present, with a finger tip to select the ink key zones.

In the color-adjustment-quantity display screen 32a, the four display sections 36, 37, 38, and 39 that display a color adjustment quantity for each of the ink key zones of the image are provided in association with black (K), cyan (C), magenta (M), and yellow (Y) as the four ink colors. In this case, horizontal lines in the respective display sections 36, 37, 38, and 39 are the last adjustment reference values, increases in color adjustment quantities to be adjusted this time are displayed as bar graphs extending upward, and decreases in the color adjustment quantities are displayed as bar graphs extending downward. The reset switches 40 for resetting adjustment quantities of the adjusted respective ink colors to zero are provided below the color-adjustment-quantity display screen 32a. In the color-adjustment-quantity display screen 32, as in the image display screen 31, it is possible to set ink key zones in which color adjustment is performed.

Eight adjustment switches 41a, 41b, 42a, 42b, 43a, 43b, 44a, and 44b for setting color adjustment quantities (increases or decreases) of black (K), cyan (C), magenta (M), and yellow (Y) as the four ink colors are provided in the color-adjustment-quantity operation screen 33a. The transmission switch 46 is provided in a side part of the color-adjustment-quantity operation screen 33a.

Therefore, when ink key zones in which color adjustment is performed are set in the image display screen 31 (or the color-adjustment-quantity display screen 32a), the operator can input an indication value (an increase/decrease value or a decrease value) of color adjustment for each of the ink colors by touching any one of the adjustment switches 41a, 41b, 42a, 42b, 43a, 43b, 44a, and 44b of the color-adjustment-quantity operation screen 33a. Then, according to the operation of any one of the adjustment switches 41a, 41b, 42a, 42b, 43a, 43b, 44a, and 44b, the indication value, i.e., an increase/decrease for each of black (K), cyan (C), magenta (M), and yellow (Y) as the ink components is displayed on the color-adjustment-quantity display screen 32a.

In this case, when color adjustment work for each of ink key zones selected is performed a plurality of times, a color adjustment quantity added with the increase/decrease for each of black (K), cyan (C), magenta (M), and yellow (Y) as the ink components is displayed on the color-adjustment-quantity display screen 32a. In other words, a total quantity of color adjustment quantities for the ink components is displayed on the color-adjustment-quantity display screen 32a. The operator can collectively transmits the total quantity of the color adjustment quantities displayed on the color-adjustment-quantity display screen 32a to the arithmetic unit 12 by operating the transmission switch 46.

In this way, the color adjustment work for a print image is performed using the color-adjustment-quantity operation careen 33a, which is displayed by operating the switch by unit 45, to directly input an indication value for a color adjustment quantity for each of black (K), cyan (C), magenta (M), and yellow (Y) as the ink components to a plurality of ink key zones selected for performing color adjustment. This makes it possible to easily adjust an increase/decrease in an ink component for each of the ink key zones and realize improvement of workability by realizing simplification of the color adjustment work.

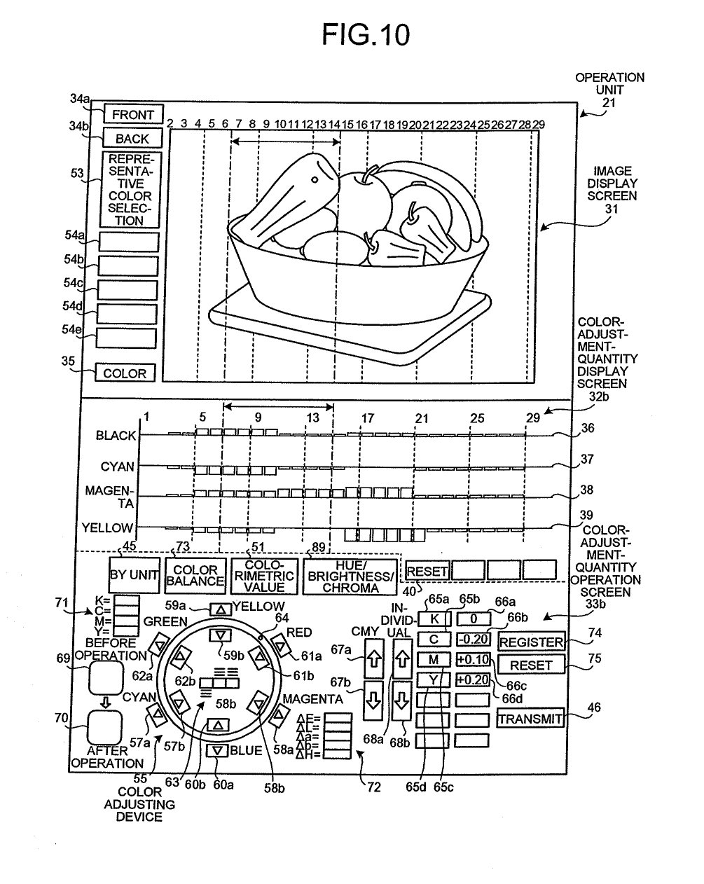

When the color balance switch 73 is operated, the image display screen 31, a color-adjustment-quantity display screen 32b, and a color-adjustment-quantity operation screen 33b shown in FIG. 10 are displayed. The image display screen 31 can display a print image based on PPF data. In a side part of the image display screen 31, the sheet selection switches 34a and 34b for selecting the front and the back of a print sheet and the color selection switch 35 for displaying an image with one of black, cyan, magenta, and yellow as four ink colors are provided. Further, in the side part of the image display screen 31, the representative-color selection switch 53 for selecting a representative image (a representative color) in the image displayed on the image display screen 31 is provided. Moreover, the five representative-color display sections (the storing units) 54a, 54b, 54c, 54d, and 54e that store and display the representative color selected are provided.

Therefore, for example, when an image of a large number of fruits in a basket is displayed on the image display screen 31 and the operator desires to adjust a color of a specific fruit in the image of the fruits, the operator can set ink key zones, in which color adjustment is performed, by touching the ink key zones No. 7 to 14, in which the fruit is present, with a finger tip to select the ink key zones. When the operator desires to perform color adjustment for a specific portion of the fruit, the operator can display an image of the specific portion on one of the five representative-color display sections 54a, 54b, 54c, 54d, and 54e and store the image therein by touching the representative-color selection switch 53 and, then, touching the specific portion (a representative image) of the fruit with a fingertip. In this case, it is possible to store five representative images. The operator can also display the image of the specific portion on one of the representative-color display sections 54a, 54b, 54c, 54d, and 54e and store the image therein by touching the specific portion (the representative image) of the fruit with a finger tip and, then, touching the representative-color selection switch 53.

In the color-adjustment-quantity display screen 32b, the four display sections 36, 37, 38, and 39 that display a color adjustment quantity for each of the ink key zones of the image are provided in association with black (K), cyan (C), magenta (M), and yellow (Y) as the four ink colors. The reset switches 40 for resetting adjustment quantities of the adjusted respective ink colors to zero are provided below the color-adjustment-quantity display screen 32b.

The color-adjustment-quantity operation screen 33b includes a color adjusting device 55 for setting color adjustment quantities for cyan (C), magenta (M), and yellow (M) as three ink colors. The color adjusting device 55 includes adjustment switches 57a, 57b, 58a, 58b, 59a, and 59b provided on the inner side and the outer side of a ring 56 and used for increasing or decreasing color adjustment quantities of cyan (C), magenta (M), and yellow (Y) and adjustment switches 60a, 60b, 61a, 61b, 62a, and 62b for increasing or decreasing color adjustment quantities of blue, red, and green, which are intermediate colors of cyan (C), magenta (M), and yellow (Y). A graph display section 63 that displays the color adjustment quantities for cyan (C), magenta (M), and yellow (Y) as a graph is provided in the center of the ring 56. A degree display section 64 that displays a degree of the color adjustment is provided in the ring 56.

In a lateral direction of the color adjusting device 55, the selection switches 65a, 65b, 65c, and 65d corresponding to cyan (C), magenta (M), yellow (Y), and black (K) are provided and the control-quantity display sections 66a, 66b, 66c, and 66d that display control quantities (adjustment quantities) of the respective colors are provided. The density adjustment switches 67a and 67b for increasing or decreasing cyan (C), magenta (M), and yellow (Y) by the same quantity, i.e., adjusting densities thereof are provided and the individual adjustment switches 68a and 68b for individually increasing or decreasing cyan (C), magenta (M), yellow (Y), and black (K) are provided next to the selection switches and the control-quantity display sections.

Beside the color adjusting device 55, a pre-operation display section (a pre-adjustment display section) 69 that displays a representative color (a representative image) before color adjustment operation is performed and a post-operation display section (a post-adjustment display section) 70 that displays a representative color (a representative image) after color adjustment operation is performed are provided. In this case, it is possible to display a representative color based on PPF data on the pre-operation display section 69. It is possible to display a representative color adjusted by the color adjusting device 55 on the post-operation display section 70. The representative colors displayed on the pre-operation display section 69 and the post-operation display section 70 are representative colors of a representative image selected with the representative-color selection switch 53. The area-ratio display section 71 that displays area ratios of respective colors in this representative image is provided above the pre-operation display section 69.

The color-adjustment-quantity operation screen 33b includes the color-difference display section 72 that displays, in the representative image, a difference between a print color before adjustment displayed on the pre-operation display section 69 and a print color after adjustment displayed on the post-operation display section 70 using a deviation value in a CIELAB color space. In the color-difference display section 72, a deviation Δa in an “a” axis direction, a deviation Δb in a “b” axis direction, a color difference ΔE between “a” and “b”, a deviation ΔL (or brightness) in an L axis direction crossing the “a” axis and the “b” axis, and a deviation ΔH of a hue in the CIELAB color space are displayed. The color balance switch 73 is provided above the color-adjustment-quantity operation screen 33b. The registration switch 74, the reset switch 75, and the transmission switch 46 are provided in a side part of the color-adjustment-quantity operation screen 33b.

Therefore, when an ink key zone in which color adjustment is performed is set and a representative image is selected with the representative-color-selection switch 53 in the image display screen 31 (or the color-adjustment-quantity display screen 32b), the operator touches any one of the adjustment switches 57a, 57b, 58a, 58b, 59a, and 59b and the adjustment switches 60a, 60b, 61a, 61b, 62a, and 62b of the color-adjustment-quantity operation screen 33b.

In this way, the operator can input an indication value (an increase/decrease value or a decrease value) of color adjustment for each of the ink colors (cyan, magenta, and yellow) or the intermediate colors of the ink colors (blue, red, and green). In this case, for example, when the operator operates the adjustment switches 61a and 61b corresponding to red, since cyan and yellow of the ink colors are simultaneously adjusted, operation loads are reduced. Then, according to the operation of the respective adjustment switches 57a, 57b, 58a, 58b, 59a, 59b, 60a, 60b, 61a, 61b, 62a, and 62b, the indication value, i.e., an increase/decrease for each of black (K), cyan (C), magenta (M), and yellow (Y) as the ink components is displayed on the control-quantity display sections 66a, 66b, 66c, and 66d as a numerical value. The increase/decrease is also displayed on the color-adjustment-quantity display screen 32 as a bar graph.

In the color-adjustment-quantity operation screen 33b, the representative color of the representative image based on the PPF data is displayed on the pre-operation display section 69 and the representative color of the representative image adjusted by the color adjusting device 55 is displayed on the post-operation display section 70. The operator can perform color adjustment while comparing the representative colors displayed on the pre-operation display section 69 and the post-operation display section 70. Moreover, the operator can perform color adjustment while looking at the control-quantity display sections 66a, 66b, 66c, and 66d, the area-ratio display section 71, and the color-difference display section 72 as standards.

When color adjustment is applied to a plurality of ink key zones or a plurality of representative images, it is possible to store an indication value for a color adjustment quantity at that point in the color-adjustment-quantity display screen 32b by operating the registration switch 74 every time color adjustment is performed. It is possible to cancel the indication value for the color adjustment quantity at that point by operating the reset switch 75.

In this way, the color adjustment work for a print image is performed using the color-adjustment-quantity operation careen 33b, which is displayed by operating the color balance switch 73, to directly input not only an indication value for a color adjustment quantity for each of black (K), cyan (C), magenta (M), and yellow (Y) as the ink components but also an indication value for a color adjustment quantity for each of the intermediate colors thereof to a plurality of ink key zones selected for performing color adjustment. This makes it possible to easily adjust an increase/decrease in an ink component for each of the ink key zones and realize improvement of workability by realizing simplification of the color adjustment work.

A representative color before color adjustment is displayed on the pre-operation display section 69. When the operator operates the color adjusting device 55 to input an indication value for color adjustment, a representative color after adjustment is displayed on the pre-operation display section 70. Therefore, the operator can check whether an adjustment intention of the operator is reflected on the representative color after color adjustment by comparing the representative color before color adjustment displayed on the pre-operation display section 69 and the representative color after color adjustment displayed on the pre-operation display section 70. It is possible to reduce a print time and work cost by reducing the number of times of test print.

The color-difference display section 72 that displays, in a representative image selected, a difference between a print color before adjustment based on image information and a print color after adjustment based on a color adjustment quantity using a deviation value in the CIELAB color space is provided. Therefore, the operator can perform color adjustment for a print color while checking the deviation value on the color-difference display section 72 and improve workability.

Moreover, the representative-color selection switch 53 for selecting a representative image (a representative color) in a print image displayed on the image display screen 31 and the representative-color display sections 54a, 54b, 54c, 54d, and 54e that store and display the representative color selected are provided. Therefore, it is possible to easily adjust a predetermined color in a predetermined portion, which the operator desires to subject to color adjustment in particular, by selecting a representative image in an ink key zone. It is possible to easily repeat color adjustment for pixels in the same portion by storing the representative image selected.

When the calorimetric value switch 51 is operated, the image display screen 31, the color-adjustment-quantity display screen 32, and the color-adjustment-quantity operation screen 33 shown in FIG. 1 are displayed. Since the screens are explained in the first embodiment, explanations of the screens in this embodiment are omitted.

When the hue/brightness/chroma switch 9 is operated, the image display screen 31, a color-adjustment-quantity display screen 32c, and a color-adjustment-quantity operation screen 33c are displayed. The image display screen 31 can display a print image based on PPF data as described above. Therefore, the operator can set an ink key zone in which color adjustment is performed and displays five representative images on the representative-color display sections 54a, 54b, 54c, 54d, and 54e and store the representative images therein using the representative-color selection switch 53.

In the color-adjustment-quantity display screen 32c, the four display sections 36, 37, 38, and 39 that display a color adjustment quantity for each of ink key zones of an image and the reset switches 40 for resetting adjustment quantities of adjusted respective ink colors to zero are provided in association with black (K), cyan (C), magenta (M), and yellow (Y) as the four ink colors.

In the color-adjustment-quantity operation screen 33c, a color adjusting device 83 for setting a color adjustment quantity based on a hue, brightness, and chroma is provided in association with cyan (C), magenta (M), and yellow (Y) as the ink colors. The color adjusting device 83 includes adjustment switches 84a, 84b, 85a, 85b, 86a, and 86b for increasing or decreasing the color adjustment value based on a hue, brightness, and chroma. In the center of each of the adjustment switches 84a, 84b, 85a, 85b, 86a, and 86b, a pre-operation display section 87 that displays a representative color (a representative image) before color adjustment operation is performed and a post-operation display section 88 that displays a representative color (a representative image) after color adjustment operation is performed are provided. In this case, it is possible to display a representative color based on PPF data on the pre-operation display section 87 and display a representative color adjusted by the color adjusting device 83 on the post-operation display section 88.

The color-adjustment-quantity operation screen 33c includes the area-ratio display section 71 that displays area ratios of the respective colors in this representative image. The color-adjustment-quantity operation screen 82 includes the color-difference display section 72 that displays, in the representative image, a difference between a print color before adjustment displayed on the pre-operation display section 69 and a print color after adjustment displayed on the post-operation display section 70 using a deviation value in a CIELAB color space.

In a lateral direction of the color adjusting device 83, the selection switches 65a, 65b, 65c, and 65d corresponding to cyan (C), magenta (M), yellow (Y), and black (K), the control-quantity display sections 66a, 66b, 66c, and 66d that display control quantities (adjustment quantities) of the respective colors, the density adjustment switches 67a and 67b for increasing or decreasing cyan (C), magenta (M), and yellow (Y) by the same quantity, i.e., adjusting densities thereof, and the individual adjustment switches 68a and 68b for individually increasing or decreasing cyan (C), magenta (M), yellow (Y), and black (K) are provided. The registration switch 74, the reset switch 75, and the transmission switch 46 are provided in the lateral direction of the color-adjustment-quantity operation screen 82.

Therefore, when an ink key zone in which color adjustment is performed is set and a representative image is selected with the representative-color-selection switch 53 in the image display screen 31 (or the color-adjustment-quantity display screen 32), the operator can input an indication value (an increase/decrease value or a decrease value) for color adjustment for each of a hue, brightness, and chroma by touching any one of the adjustment switches 84a, 84b, 85a, 85b, 86a, and 86b of the color adjusting device 83 in the color-adjustment-quantity operation screen 33c. Then, according to the operation of the respective adjustment switches 84a, 84b, 85a, 85b, 86a, and 86b, the indication value, i.e., an increase/decrease for each of black (K), cyan (C), magenta (M), and yellow (Y) as the ink components is displayed on the control-quantity display sections 66a, 66b, 66c, and 66d as a numerical value. The increase/decrease is also displayed on the color-adjustment-quantity display screen 32 as a bar graph.

In the color-adjustment-quantity operation screen 33c, the representative color of the representative image based on the PPF data is displayed on the pre-operation display section 87 and the representative color of the representative image adjusted by the color adjusting device 83 is displayed on the post-operation display section 88. The operator can perform color adjustment while comparing the representative colors displayed on the pre-operation display section 87 and the post-operation display section 88. Moreover, the operator can perform color adjustment while looking at the control-quantity display sections 66a, 66b, 66c, and 66d, the area-ratio display section 71, and the color-difference display section 72 as standards.

In this way, color adjustment work for a print image is performed using the color-adjustment-quantity operation screen 33, which is displayed by operating the hue/brightness/chroma switch 89, to input an indication value for color adjustment for each of a hue, brightness, and chroma to a plurality of ink key zones selected for performing color adjustment. This makes it possible to easily adjust an increase/decrease in an ink component for each of the ink key zones and realize improvement of workability by realizing simplification of the color adjustment work. In this case, a representative value before color adjustment is displayed on the pre-operation display section 87 and a representative color after color adjustment is displayed on the post-operation display section 88. This makes it possible to check whether an adjustment intention of the operation is reflected on the representative color after color adjustment while comparing the representative color before color adjustment displayed on the pre-operation display section 69 and the representative color after color adjustment displayed on the pre-operation display section 70. Therefore, it is possible to reduce a print time and work cost by reducing the number of times of test print.

In the offset printer including the ink control apparatus according to the second embodiment, the switch by unit 45, the color balance switch 73, the calorimetric value switch 51, and the hue/brightness/chroma switch 89 of the operation unit 21 are operated to display the image display screen 31, the color-adjustment-quantity display screens 32, 32a, 32b, and 32c, and the color-adjustment-quantity operation screen 33, 33a, 33b, and 33c to make is possible to carry out color adjustment for a print image using the respective screens. This makes it possible to carry out color adjustment work using an optimum screen according to preference of the operator and improve universality of the offset printer.

In this case, various color adjustment methods may be combined using a plurality of screens for one print image to constitute an operation unit having the respective functions or any one of the functions and allow the operator to selectively use the functions according to an intention of the operator. Color adjustment work may be applied to a plurality of first ink key zones and a plurality of second ink key zones using the color-adjustment-quantity operation screen 33 and the color-adjustment-quantity operation screen 33a, respectively.

According to an aspect of the present invention, it is possible to realize improvement of workability of print work and reduce burdens on the operator by realizing simplification of color adjustment work.

According to another aspect of the present invention, the operator to can perform, by displaying an image based on the calorimetric value of the representative image in the color sample and an image based on the calorimetric value of the representative image in the print, color adjustment for an image while comparing the two images and improve workability.

According to still another aspect of the present invention, the operator to can perform color adjustment for an image while checking the corrected color and improve workability.

According to still another aspect of the present invention, the operator to can perform color adjustment for an image while checking the calorimetric value and improve workability.

According to still another aspect of the present invention, it is possible to easily repeat color adjustment for pixels in the same portion by storing a specific representative image in the storing unit.

According to still another aspect of the present invention, it is possible to adjust ink supply quantities in the ink areas easily and in a short time and improve workability by setting, for the ink areas selected, a color adjustment quantity for each of the ink areas based on the indication value.

According to still another aspect of the present invention, it is possible to adjust ink supply quantities in the respective ink areas having different image area ratios easily and in a short time and improve workability by setting, for the ink areas selected, a color adjustment quantity for each of the ink areas based on the indication value, the image area ratio, and the number of revolutions of the ink fountain roller.

According to still another aspect of the present invention, the operator can select an ink area while looking at the print pattern image in the image display section or the color adjustment quantity in the color-adjustment-quantity display section and realize improvement of workability.

According to still another aspect of the present invention, it is possible to simplify work.

According to still another aspect of the present invention, it is possible to set a color adjustment quantity for a representative image, i.e., a variation for each of the ink components in detail and easily adjust the representative image.

According to still another aspect of the present invention, it is possible to set a color adjustment quantity for an ink component according to a hue, brightness, and chroma with respect to a color to be subjected to color adjustment and indicate the color adjustment quantity easily and in detail to surely change the color adjustment quantity.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. An ink control apparatus comprising:
a display unit that displays a print pattern image based on image information;
an area selecting unit that selects a target ink area where color adjustment is to be performed from the image displayed by the display unit;
an image selecting unit that selects a representative image in the target ink area;
a calorimetric unit that measures a calorimetric value of the representative image in a color sample and a calorimetric value of the representative image in a print;
a setting unit that sets, based on the calorimetric value of the color sample and the calorimetric value of the print measured by the calorimetric unit, a color adjustment quantity for the target ink area; and
a changing unit that changes, based on the color adjustment quantity set by the setting unit, an ink supply quantity in the target ink area.

2. The ink control apparatus according to claim 1, further comprising:
a color-sample display unit that displays, in the representative image, an image based on the calorimetric value of the representative image in the color sample measured by the calorimetric unit; and
a print display unit that displays an image based on the calorimetric value of the representative image in the print measured by the calorimetric unit.

3. The ink control apparatus according to claim 2, further comprising a corrected-color display unit that displays, in the representative image, a corrected color corresponding to a deviation between the calorimetric value of the representative image in the color sample and the calorimetric value of the representative image in the print.

4. The ink control apparatus according to claim 2, further comprising a color-value display unit that displays, in the representative image, a deviation between the calorimetric value of the representative image in the color sample and the calorimetric value of the representative image in the print as a color value in a CIELAB color space.

5. The ink control apparatus according to claim 1, wherein the image selecting unit includes a storing unit that stores therein the representative image.

6. The ink control apparatus according to claim 1, wherein
the area selecting unit selects two or more target ink areas, and
the setting unit sets color adjustment quantities for the two or more target ink areas based on a pre-set value.

7. The ink control apparatus according to claim 6, wherein the changing unit sets, for each of the ink areas, a color adjustment quantity for the ink area selected by the area selecting unit based on one or more selected from a pre-set value, an image area ratio, and a number of revolutions of an ink fountain roller.

8. The ink control apparatus according to claim 1, wherein
the display unit includes:
an image display unit that displays a print pattern image based on the image information by sectioning the print pattern image into a plurality of ink areas; and
a color-adjustment-quantity display unit that displays the color adjustment quantity set by the setting unit for each of the ink areas, and
the area selecting unit selects the target ink area by using the image display unit or the color-adjustment-quantity display unit.

9. The ink control apparatus according to claim 1, wherein the setting unit sets a color adjustment quantity corresponding to each component of the ink.

10. The ink control apparatus according to claim 1, wherein the setting unit sets color adjustment quantities corresponding to each component of the ink and intermediate colors of the ink components.

11. The ink control apparatus according to claim 1, wherein the setting unit sets a color adjustment quantity for each component of the ink based on a hue, brightness, and chroma.

12. A printer comprising:
an ink supply unit that is capable of adjusting an ink supply quantity for each of ink areas sectioned in a print width direction;
a display unit that displays a print pattern image based on image information;
an area selecting unit that selects a target ink area where color adjustment is to be performed from the image displayed by the display unit;
an image selecting unit that selects a representative image in the target ink area;
a calorimetric unit that measures a calorimetric value of the representative image in a color sample and a calorimetric value of the representative image in a print;
a setting unit that sets, based on the calorimetric value of the color sample and the calorimetric value of the print measured by the calorimetric unit, a color adjustment quantity for the target ink area; and
a changing unit that changes, based on the color adjustment quantity set by the setting unit, an ink supply quantity in the target ink area.

13. A printing method comprising:
displaying a print pattern image based on image information;
selecting a target ink area where color adjustment is to be performed from the image displayed at the displaying;
selecting a representative image in the target ink area;
measuring a calorimetric value of the representative image in a color sample and a calorimetric value of the representative image in a print;
setting, based on the calorimetric value of the color sample and the calorimetric value of the print measured at the measuring, a color adjustment quantity for the target ink area; and
changing, based on the color adjustment quantity set at the setting, an ink supply quantity in the target ink area.
